(19) United States
(12) Patent Application Publication
(10) Pub. No.: US 2018/0260747 A1
(43) Pub. Date: Sep. 13, 2018

(54) AUDIT AND COMPLIANCE SYSTEM AND METHOD

(71) Applicant: X 14 Systems Pty Ltd., Brisbane, Queensland (AU)

(72) Inventors: Greg BERGSMA, Brisbane (AU); David HARRIS, Brisbane (AU)

(73) Assignee: X14 Systems Pty Ltd., Brisbane, Queensland (AU)

(21) Appl. No.: 15/755,259

(22) PCT Filed: Aug. 24, 2016
(86) PCT No.: PCT/AU16/50774

§ 371 Date: Feb. 26, 2018

(30) Foreign Application Priority Data
Aug. 25, 2015 (AU) 2015903424
Apr. 29, 2016 (AU) 2016901581

(51) Int. Cl. G06Q 10/06

(52) U.S. Cl. CPC G06Q 10/0635; G06Q 10/06393; G06Q 10/06395

(57) ABSTRACT

An audit method and system is provided that can be customised to suit a variety of processes, and enables an auditor to focus on compliance criteria rather than standards, legislation, regulations and codes. The method includes receiving an audit definition, the audit definition including a plurality of compliance criteria; providing the compliance criteria to an auditor according to the audit definition; receiving audit data in response to the compliance criteria; and generating a compliance report based upon the received audit data.

### TECHNICAL FIELD

The present invention relates to audit and compliance systems. In particular, but not exclusively, the present invention relates to audit and compliance systems for process, business or organisational governance and assurance.

### BACKGROUND ART

Regulatory compliance has become increasingly important in recent years, as both new legislation has been introduced and the legal requirements regarding compliance with existing legislation has become more stringent.

Businesses and organisations are now generally required to comply with a large number of standards, which are often very complex. Furthermore, organisations often impose on themselves additional corporate and social values, beyond what is required by law. It is also desirable to monitor and audit such voluntary compliance, to provide validity to any claims of such compliance.

As such, identifying all relevant obligations that apply to a business, as well as any potential implications of non-compliance, can be very complex and thus time consuming. This complexity leads to situations where some compliance requirements are not identified and actioned, and thus organisations accept the risk of non-compliance.

Furthermore, even auditors have trouble keeping up to date with the variety of standards. In particular, understanding the breadth of compliance requirements is taxing, and trawling through standards, legislation, regulations and codes is time consuming. Similarly, the chances of human error increase in accordance with the complexity of the compliance environment

As such, there is a need for improved audit and compliance systems.

It will be clearly understood that, if a prior art publication is referred to herein, this reference does not constitute an admission that the publication forms part of the common general knowledge in the art in Australia or in any other country.

### SUMMARY OF INVENTION

The present invention is directed to audit and compliance systems, which may at least partially overcome at least one of the abovementioned disadvantages or provide the consumer with a useful or commercial choice.

With the foregoing in view, the present invention in one form, resides broadly in an audit method comprising:

receiving an audit definition, the audit definition including a plurality of compliance criteria;

providing the compliance criteria to an auditor according to the audit definition;

receiving audit data in response to the compliance criteria; and

generating a compliance report based upon the received audit data.

The audit definition enables the method to be applied across many domains of a business as the audit method may be customised to any suitable business processes. Furthermore, an auditor can focus on the compliance criteria without having to trawl through the standards, legislation, regulations and codes, as they are automatically retrieved from the audit definition and provided to the auditor.

The audit definition may comprise an audit template. The audit template may comprise a Microsoft Excel worksheet.

The audit data may be input by an auditor by making a selection. Suitably, the selection comprises checking a checkbox or pressing a button. As such, the audit data may be efficiently input by the auditor.

Preferably, the audit data is saved with the audit definition or an identifier thereof. As such, the audit data is associated with the definition from which it was created, thus removing any ambiguity regarding how the audit data was created.

According to some embodiments, supporting evidence is provided with the audit data. The supporting evidence may comprise photographs, images, audio files, and/or inspection data.

The audit definition may be defined hierarchically. The report may present the audit results hierarchically. This provides the ability for those reviewing the report to drill down on results from an executive level through to an operational level.

Preferably, the audit definition includes reference to a standard, legislation, regulation, a code of practice and/or self-imposed standards. In particular, each of the compliance criteria may be associated with a standard, legislation, regulation, a code of practice and/or self-imposed standards.

The audit definition may include guidance elements, for presentation to the auditor. The guidance elements may comprise hints to help the auditor to interpret each of the compliance criteria.

Preferably, the method includes analysis of the received audit data.

Preferably, the report is generated according to a report template. The report template may comprise a Microsoft Word document and/or a Microsoft Excel workbook. The report template may include layout data and code defining an interaction with the audit data.

Preferably, a data trail (metadata) is saved together with the audit data. The data trail may include details of when the audit data was entered.

Preferably, the method further comprises receiving additional input data in association with the audit data. Examples of additional input data includes findings, observations and existing risk controls, strengths and weaknesses, and problems, risks and solutions by the auditor. The additional input data may be included in the report.

Preferably, a plurality of audit templates are generated, and one template is selected for each audit.

In another form, the present invention resides broadly in an audit system comprising:

a data interface;

a processor coupled to the data interface; and

a memory, coupled to the processor, the memory including instruction code executable by the processor for:
receiving, on the data interface, an audit definition, the audit definition including a plurality of compliance criteria;
providing, on the data interface, the compliance criteria to an auditor according to the audit definition;
receiving, on the data interface, audit data in response to the compliance criteria; and
generating a compliance report based upon the received audit data.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates an audit management system, according to an embodiment of the present invention;

FIG. 2 illustrates a screenshot of an audit template in the form of a Microsoft Excel Worksheet, according to an embodiment of the present invention;

FIG. 3 illustrates a screenshot of an audit template management screen of the system of FIG. 1, according to an embodiment of the present invention;

FIG. 4 illustrates a screenshot of an audit creation screen of the system of FIG. 1, according to an embodiment of the present invention;

FIG. 5a illustrates a screenshot of an audit screen of the system, according to an embodiment of the present invention;

FIG. 5b illustrates a further screenshot of the audit screen of FIG. 5a;

FIG. 6 illustrates a screenshot of a portion of a report template in the form of an action plan task summary template, according to an embodiment of the present invention; and

FIG. 7 illustrates a screenshot of an impact summary screen of the system of FIG. 1, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

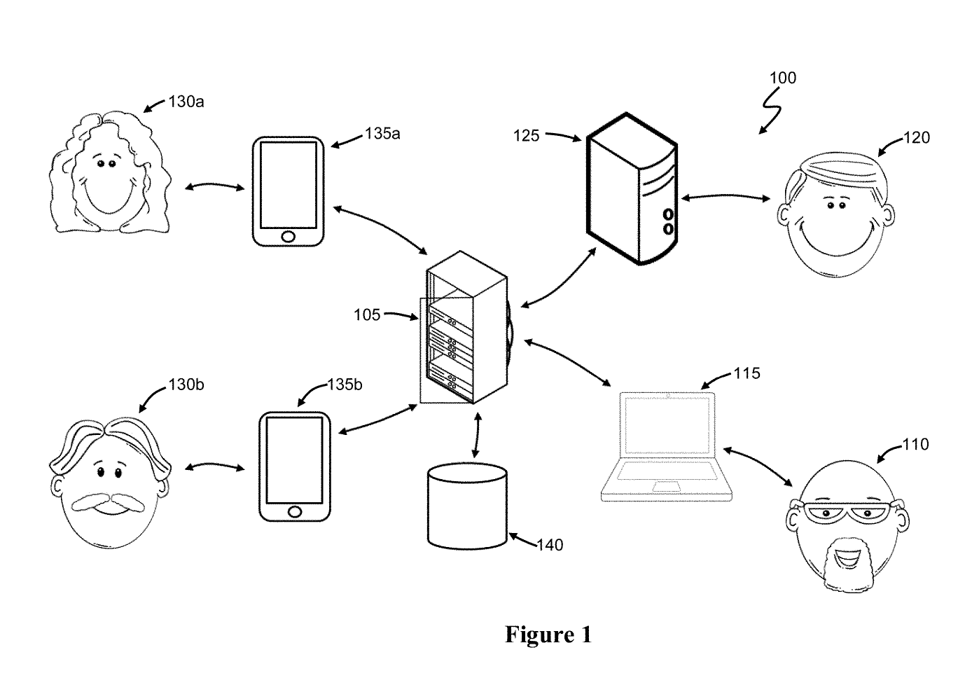

FIG. 1 illustrates an audit management system 100, according to an embodiment of the present invention. As described in further detail below, the system 100 enables the setup and establishment of a governance and auditing infrastructure, the conduct of audit and assurance activities, and reporting and analysis of the audit and assurance activities.

The system 100 includes an audit server 105, with which an audit template designer 110 initially interacts through an audit template device 115. In particular, the audit template designer 110 generates a plurality of audit templates, which are uploaded onto the audit server 105 for use by others.

The process of generating an audit template generally starts through the identification of relevant standards, legislation, regulation, codes of practice and/or self-imposed standards that are relevant to the particular audit. Once identified, these standards and legislation are used to define the audit template as a spreadsheet or workbook, such as an Excel workbook. In particular, assurance category levels are identified, criteria are recorded, and references to the standards and legislation, together with what the auditor should be looking for as evidence, are generated and input into the spreadsheet or workbook.

In practice, several audit template designers 110 interact with the system 100 to produce a large number of templates. This enables the system 100 to be used for various types of auditing, as well as the ability to create custom templates as required.

A report template designer 120 also interacts with the audit server 105 through a report template device 125. In particular, the report template designer 120 generates a plurality of report templates, which are uploaded onto the audit server 105 for use by others.

Auditors, or other users, can tailor report templates to their own requirements. Each template generally contains special text, i.e. code, which indicates where certain data is to be placed in the report. As such, reports can be automatically generated according to various requirements of a business.

The report template may be in Microsoft Word format, with the content being populated through direct manipulation of XML content of the template, and/or through macros. Either way, report data and layout data is used to produce the final report.

Finally, a plurality of auditors 130a, 130b interact with the audit server 105 through respective audit devices 135a, 135b. The auditors 130a, 130b each select an audit template and enter audit data according thereto. The auditors 130a, 130b then select a report template to generate a report based upon the entered data.

Upon selection of the audit definition template, a copy of the template is saved in a database 140, together with data of the audit. This ensures that upon later review, the audit data is viewed and interpreted in light of the template used at the time of the audit, and regardless of any later updates the chosen template.

The auditors 130a, 130b generally associate the audit with an audit client, an auditee, and a name. As such, the auditor is able to categorise the audits, and group audits together, for example based upon audit client or auditee, and thus quickly identify audits for later review.

In performing the audit, the auditor generally selects risk, scoring and priority schemes, and enters audit data in relation thereto. The data may comprise a selection (e.g. ticking a box, or selecting a button), or text that has been entered by the user, as discussed in further detail below.

In particular, for each criterion of the audit template, data is entered by the auditor. Automatic scoring may be provided by the system according to a scoring scheme identified in the audit template. The scoring may be based upon compliance/non-compliance, indicate partial compliance, or indicate a level of compliance on a scale.

In some situations, the scoring can be overridden by the auditor and an explanation may be recorded. This is particularly advantageous when criteria may be exempt from an audit under certain circumstances.

Together with the audit data, the auditor may enter strengths and weaknesses associated with certain criteria, as well as recommendations in relation to a problem, details of a risk and a potential solution thereto, and timing and responsibility associated therewith (if known).

In association with the audit data, supporting evidence may be provided by the auditor. Examples of supporting evidence include photographs, images, audio files, inspection data, or the like. As such, the audit data may include not only data relating to compliance, but also evidence of same. Such evidence may be used to verify an accuracy of the audit data and prevent false audit data from being entered.

Finally, the system 100 may include recording of audit close-out information, including constraints and conclusions, and recording of liaison confirmation and consultation, such as daily meetings, an in-brief, and an out-brief.

The audit template device 115 and the report template device 125 are illustrated as a laptop and a personal computer respectively. However, the skilled addressee will readily appreciated that any suitable computational device may be used including a tablet computer, a smartphone, and a purpose built device.

Similarly, the audit device 135a, 135b are illustrated as tablet computing devices. However, any suitable computational device may be used including a personal computer, a smartphone, a laptop and a purpose built device.

Furthermore, while the audit template designer 110, the report template designer 120, and the auditors 130a, 130b are illustrated as separate users, the skilled addressee will readily appreciate that an auditor 130a, 130b may also act as the audit template designer 110 and the report template designer 120, and using a single computing device.

The system 100 generally includes user authentication and organisation setup functionality. This enables the system 100 to be used by various users, such as auditors 130a, 130b, independently of each other, while keeping data from different auditors, and in relation to different organisations, separate.

The organisation setup may enable audit clients, auditees and auditors to generate accounts and enter details of their name, description, business group, contact details, and the like. Similarly, users may be granted more or less permissions by an administrator. As an illustrative example, a first user may have permission only to enter compliance data relating to a first criterion, and a second user may have permission to enter compliance data relating to a second criterion.

According to certain embodiments, reports may be generated on demand at any time during an audit. Furthermore, different types of reports (and thus report templates) may be used on a single audit (i.e. the same audit data). As an illustrative example, report templates may exist for detailed assurance reports, exit briefs, action plans, and tasking summaries.

The system 100 may include analysis tools that enable performance comparison and trend analysis across audits, across organisation groups, or across organisations. As such, problems and trends may be detected at an early stage and thus acted upon early and used as opportunities for improvement.

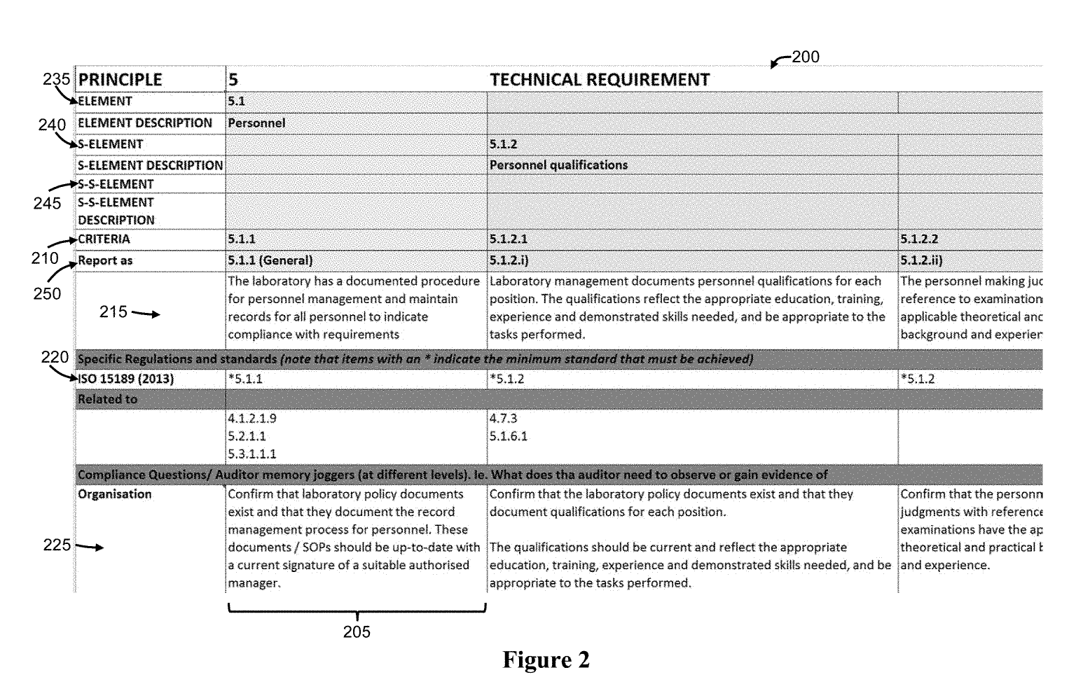

FIG. 2 illustrates a screenshot 200 of an audit template in the form of a Microsoft Excel Worksheet, according to an embodiment of the present invention.

The audit template includes a plurality of criteria 205 for each requirement of the process. The plurality of criteria 205 are arranged in columns of the worksheet.

The plurality of criteria 205 each include a criterion number field 210, providing a unique number associated with the criterion 205, a criterion description field 215, providing a description associated with the criterion 205, and a legislation field 220, providing details of legislation, standards or regulations associated with the criterion 205.

The plurality of criterion 205 also include memory joggers in the form of compliance descriptions 225 and compliance questions (not illustrated). The memory joggers assist the auditor in getting a quick understanding of the criterion 205 when performing the audit, generally by providing concrete examples of compliance (or non-compliance), and the compliance questions are generally yes/no questions defining compliance (e.g. “is there an SOP in place for personnel management?”).

The criterion 205 are organised into a plurality of categories in the form of an element 235, a sub-element 240 and a sub-sub-element 245. The categories (and levels associated therewith) each allow the auditor to group and select criterion 205 based upon category, when performing an audit, as outlined below, and to arrange audit data hierarchically when presenting or reporting the audit data.

A reporting identifier 250 is also included in relation to the criteria 205, which maps each criterion to the actual numbering of the standard. As such, when compliance (or non-compliance) is reported, it may be mapped directly to the relevant standard, even when the standard includes non-numeric, alphanumeric, or non-sequential numbering.

The audit template of FIG. 2 has been designed with reference to an organisation-level audit. Other templates may be used for division-level or section-level audits, for example.

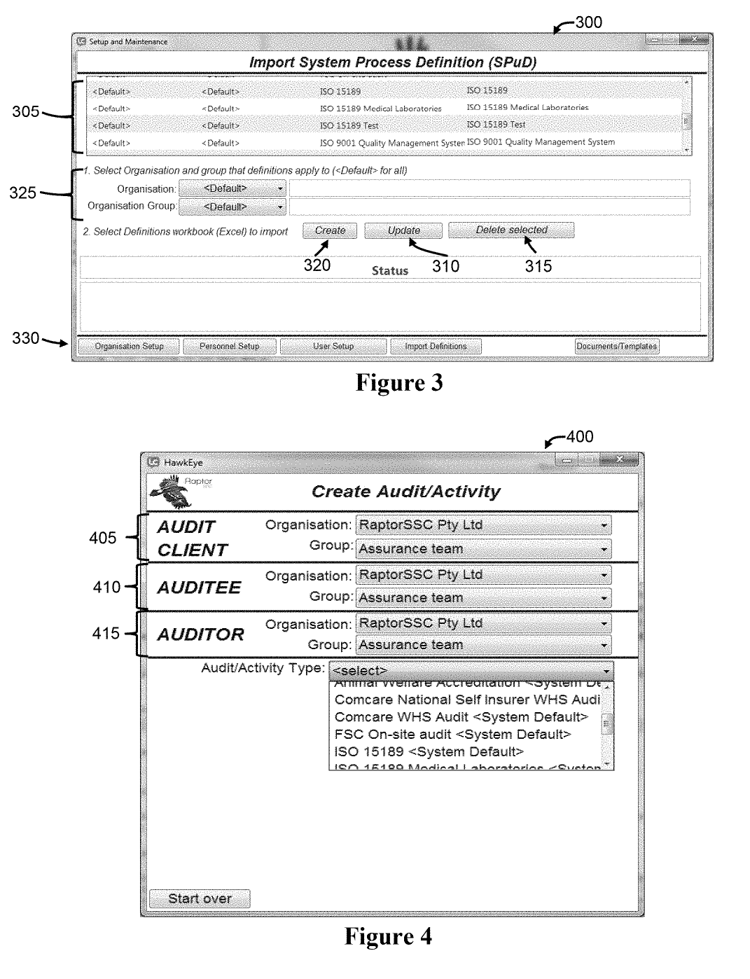

FIG. 3 illustrates a screenshot 300 of an audit template management screen of the system 100, according to an embodiment of the present invention.

The audit template management screen includes a plurality of audit elements 305, each corresponding to audit templates that have been stored on the system 100.

Each audit element 305 includes a description, and details of the organisation and organisation group with which it applies, and is selectable by the user. Upon selection of an audit element, the user is able to update the audit template associated with the audit element 305, or delete the audit template using an update button 310 and a delete button 315 respectively.

The audit template management screen further includes a create template button 320, which enables the user to create or import a new audit template to the system. The audit template may, for example, comprise a predefined template, such as a Microsoft Excel worksheet, as described above.

Organisation selection menus 325 enable the user to select an organisation and organisation group to be associated with the audit template. In case of a generic template, the user may select a default or general option, and as such, the audit template is not associated with any particular organisation. This is useful when an audit template can be applied generically to a number of organisations.

Finally, the audit template management screen includes a menu 330, which enables the user to setup a new organisation, personnel, user, or the like. This is particularly useful when the system 100 is being used by a new organisation that has not previously used the system 100.

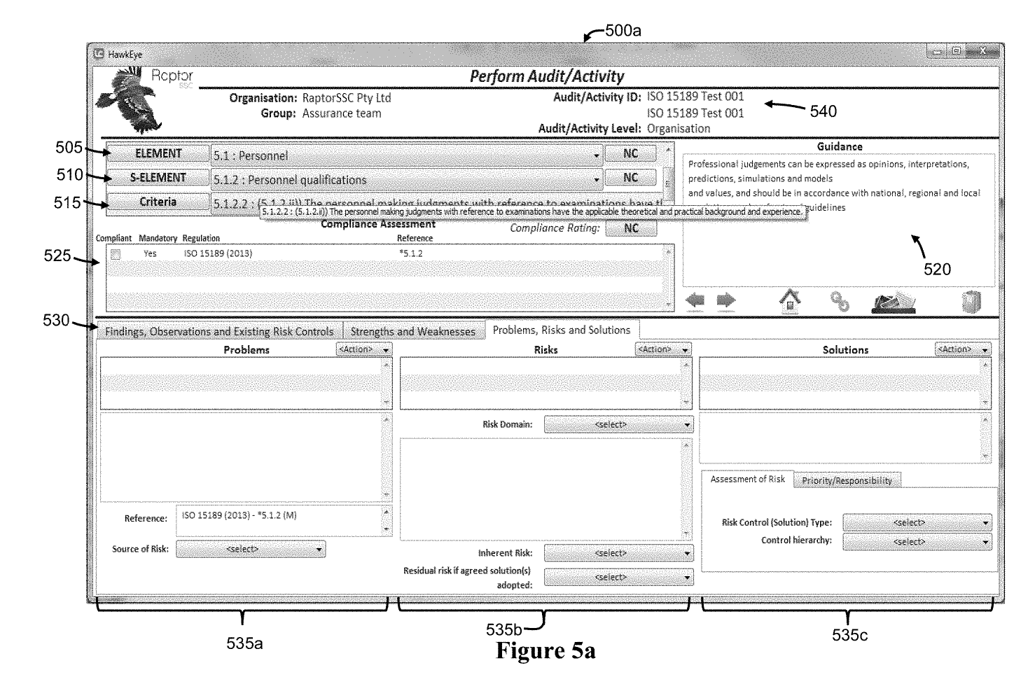

FIG. 4 illustrates a screenshot 400 of an audit creation screen of the system 100, according to an embodiment of the present invention. The audit creation screen enables an auditor to initiate an audit though selection of an audit client, an auditee and an auditor.

The audit creation screen includes an audit client selection menu 405, which comprises organisation and group drop down menus. In particular, the user is able to select the audit client first using the organisation drop down menu to select an organisation, and secondly using a group drop down menu to select a group associated with the selected organisation.

The audit creation screen further includes an auditee selection menu 410, and an auditor selection menu 415. The auditee selection menu 410 and the auditor selection menu 415 are similar to the audit client selection menu 405, and each comprise organisation and group drop down menus.

Finally, the audit creation screen includes an audit/activity type selection menu, which enables the auditor to select an audit type (and thus an audit template) to be associated with the audit.

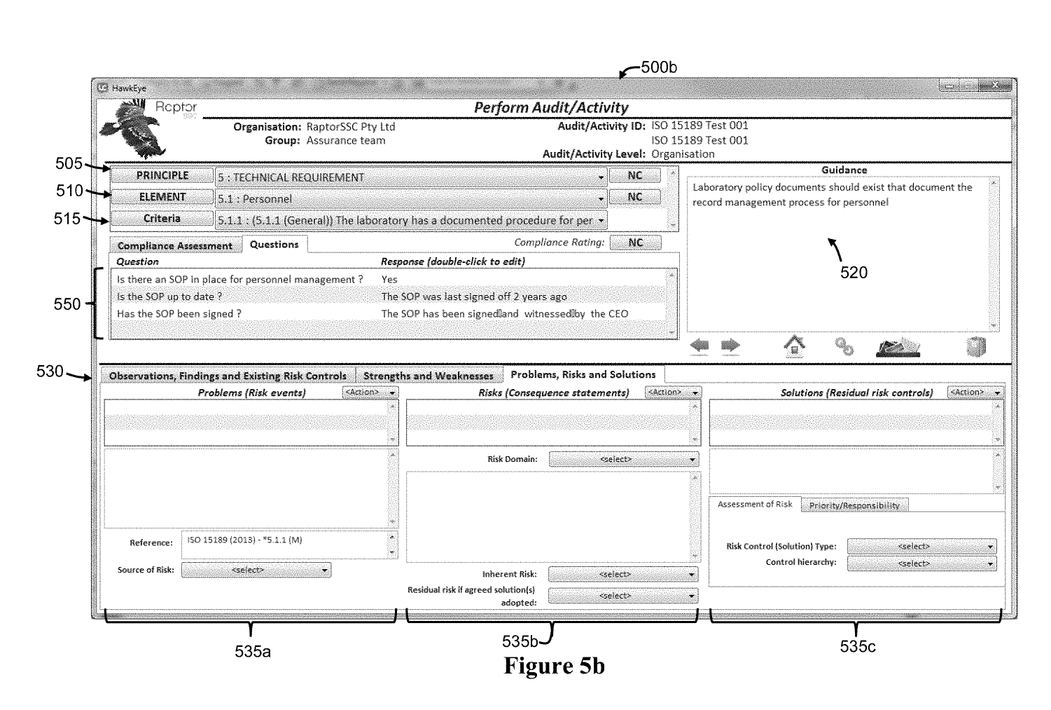

FIG. 5a illustrates a screenshot 500a of an audit screen of the system 100, according to an embodiment of the present invention.

The audit screen includes an element drop down menu 505, from which the user may select an element in relation to an audit activity. The element corresponds to the element 235 of the audit template of FIG. 2.

The audit screen includes a sub-element drop down menu 510, and a criteria drop down menu 515. The sub-element drop down menu 510 enables the user to select a sub-element associated with the selected element, and the criteria drop down menu 515 enables the user to select a criteria. The criteria correspond to the sub-element 240 of the audit template of FIG. 2. This drill down capability is provided for an unlimited number of categorisation levels as required.

The audit screen includes a guidance element 520, which provides guidance to the user in relation to the selected criteria. The guidance is generally textual, and instructs the user how to interpret the selected criteria.

The audit screen includes a compliance assessment section 525, where the user is able to input assessment data associated with the selected criteria. The compliance assessment section 525 is illustrated including a selectable tick box to indicate compliance, however according to alternative embodiments, other types of input, and combinations of input, may be used.

The audit screen further includes an additional input menu 530, which the user can use to select various types of additional input to enter in association with the compliance assessment. Examples of additional input menu items include “findings, observations and existing risk controls”, “strengths and weaknesses”, and “problems, risks and solutions”.

FIG. 5b illustrates a further screenshot 500b of the audit screen of FIG. 5a.

The audit screen includes a question/response section 550, which includes a plurality of questions, each of which the user can provide a response to. The questions are associated with the selected criteria, and responses may be entered by clicking (or double clicking) in a response area. The responses may be binary (e.g. yes/no), a selection, or free text.

FIGS. 5a and 5b are illustrated with the “problems, risks and solutions” menu item selected, and as such includes a problems input element 535a, a risks input element 535b and a solutions input element 535c. In case another additional input menu item is selected, other elements are provided in place of the problems input element 535a, the risks input element 535b and the solutions input element 535c, enabling the user to input additional data associated with the additional input menu item.

The problems input element 535a includes a textbox, in which the user may enter details of potential problems, and a risk source drop down menu, with which the user may select a risk source associated with the potential problem. The risks input element 535b and the solutions input element 535c also include similar textboxes and drop down menus and enable the user to enter details associated with risks and solutions.

Finally, the audit screen includes a header element 540, which provides an overview of the audit activity, including details of the organisation and group in relation to which the audit is being performed, and details of the type of audit. The header element 540 enables the user to quickly see an overview of the audit activity being performed, which his particularly useful when the auditor moves between multiple audit activities.

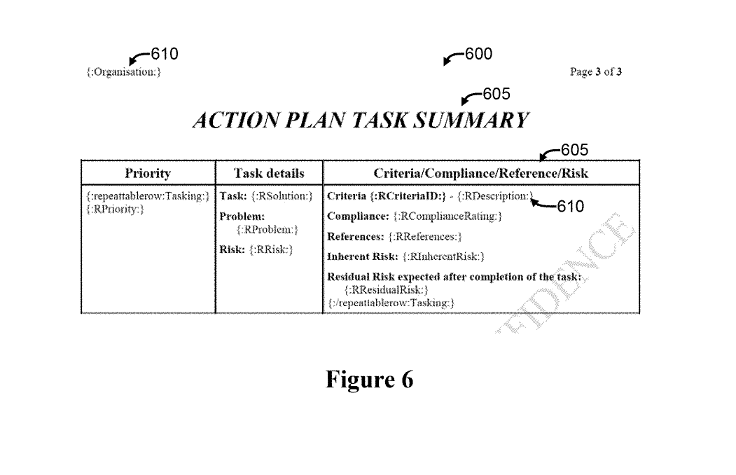

FIG. 6 illustrates a screenshot 600 of a portion of a report template in the form of an action plan task summary template, according to an embodiment of the present invention.

The report template includes a plurality of display elements 605, which are displayed in the generated report as is, and a plurality of code elements 610, which are replaced with audit data, as described above.

The report template enables a user to choose how the audit data is presented, including what is presented, where it is presented, and how it is presented. This enables the audit data to be customised for various purposes, including reporting to regulatory agencies, action plans, overviews, or any other suitable form of reporting.

According to alternative embodiments, the templates may include language replacement strings, to enable the templates to be used in a variety of languages and/or alternative terminology (eg, outcome instead of criterion). In some embodiments, a look up table may be used to select text of appropriate language.

According to certain embodiments, the system 100 includes an analysis module, which enables performance comparison and trend analysis across audits, across organisation groups, and across organisations.

The analysis module compares different, but related, audit/assurance activities, and generates performance comparison data based thereon. In some cases, the activities can be from a single auditee at different points of time, and relate to a common process. As such, the performance comparison data may provide insight in relation to performance changes over time in relation to that process by that auditee. Alternatively, the activities can be from multiple auditees and relate to a common process, to enable comparison of overall and specific performance between the auditees.

The system may be configured to plot the performance comparison data, to support strategic and operational decision making that either reinforces good performance or allows sub-optimal performance to be identified and rectified pro-actively. As such, problems and trends may be detected at an early stage and thus acted upon early and used as opportunities for improvement.

The analysis module may further be configured to define relationships between criteria, problems, risks and solutions (also known as corrective or preventative actions) such that impacts that a solution may have on related risks and problems can be identified.

In particular, relationships between related criteria are defined from an audit evidence perspective. For example if an audit criterion observation and finding is relevant to another criterion, the system prompts the relationship to be confirmed so that the finding from the one criterion is able to be related to, and analysed against, other related criterion.

Similarly if a risk event is identified during an analysis of a criterion is the same as an earlier identified risk event, a relationship between the two criteria can be defined such that the two criteria are both related to the risk event, and potentially to, common risk consequences and risk solutions as well. As such, the analysis module can be used to show the impact that a solution may have on related risks, problems and overall compliance against criteria, which in turn allows for actions to be chosen based upon overall impact.

According to certain embodiments, the analysis module is configured to plot number of items addresses in relation to a plurality of solutions (i.e. an impact summary), to assist in selecting solutions that most effectively address items, and to relate possible risk consequences to risk events and the criteria that are satisfied.

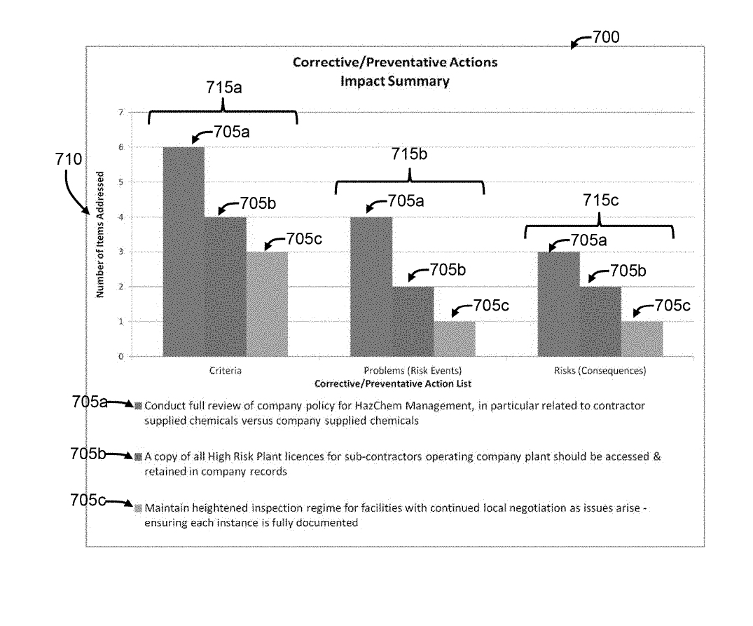

FIG. 7 illustrates a screenshot 700 of an impact summary screen of the system 100, according to an embodiment of the present invention. The impact summary screen illustrates an impact of a number of solutions 705a, 705b, 705c in relation to items addressed 710, for criteria 715a, problems (risk events) 715b, and risks (consequences) 715c.

The first solution 705a relates to conducting a full review of company policy for Haz Chem Management, and in particular relating to contractor supplied chemicals versus company supplied chemicals. The impact summary screen illustrates the first solution 705a being associated with three (3) different potential risks (consequences) 715c, such as reputation, finance (fines) and personnel health, four (4) problems (risk events) 715b, such as labelling issues, storage issues, decanting issues and personal protective equipment (PPE) related issues and six (6) audit criteria 715a.

Similarly, the second solution 705b is illustrated as being associated with two (2) different potential risks (consequences) 715c, two (2) problems (risk events) 715b and four (4) audit criteria 715a, and the third solution 705c is illustrated as being associated with one (1) potential risk (consequence) 715c, one (1) problem (risk event) 715b and three (3) audit criteria 715a.

As such, the impact summary screen clearly and concisely illustrates that the first solution 705a addresses six (6) separate but related weaknesses in six (6) criteria 715a, four (4) problems 715b and three (3) separate but related risks, which is more than either of the second solution 705b, or the third solution 705c. As such, the user may see that the most items may be addressed with the first solution 705a, assisting the user in making that decision on which solution to implement first.

The present invention simplifies the process of performing audits, increases consistency between audits, and enables efficient analysis of audit results.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An audit method comprising:
receiving an audit definition, the audit definition including a plurality of compliance criteria;
providing the compliance criteria to an auditor according to the audit definition;
receiving audit data in response to the compliance criteria; and
generating a compliance report based upon the received audit data.

2. The method of claim 1, wherein the audit definition comprises an audit template.

3. The method of claim 1, wherein the audit data is input by an auditor by making a selection.

4. The method of claim 3, wherein making the selection comprises checking a checkbox or pressing a button.

5. The method of claim 1, wherein the audit data is saved with the audit definition or an identifier of the audit definition.

6. The method of claim 1, wherein supporting evidence is provided with the audit data.

7. The method of claim 6, wherein the supporting evidence comprises one or more of photographs, images, audio files, and inspection data.

8. The method of claim 1, wherein the audit definition is defined hierarchically.

9. The method of claim 8, wherein report is configured to present the audit results hierarchically.

10. The method of claim 1, wherein the audit definition includes reference to at least one of a standard, legislation, regulation, a code of practice and a self-imposed standard.

11. The method of claim 10, wherein each of the compliance criteria is associated with at least one of a standard, legislation, regulation, a code of practice and a self-imposed standards.

12. The method of claim 1, wherein the audit definition includes guidance elements, for presentation to the auditor.

13. The method of claim 1, further comprising analyzing the received audit data.

14. The method of claim 1, wherein the report is generated according to a report template.

15. The method of claim 14, wherein the report template includes layout data and code defining an interaction with the audit data.

16. The method of claim 1, wherein a data trail (metadata) is saved together with the audit data.

17. The method of claim 16, wherein the data trail includes details of when the audit data was entered.

18. The method of claim 1, further comprising receiving additional input data in association with the audit data.

19. The method of claim 18, wherein the additional input data includes one or more of findings, observations and existing risk controls, strengths and weaknesses, and problems, risks and solutions by the auditor.

20. The method of claim 18, wherein the additional input data is included in the report.

21. The method of claim 1, wherein a plurality of audit templates are generated, and one template is selected for each audit.

22. An audit system comprising:
a data interface;
a processor coupled to the data interface; and
a memory, coupled to the processor, the memory including instruction code executable by the processor for:
receiving, on the data interface, an audit definition, the audit definition including a plurality of compliance criteria;
providing, on the data interface, the compliance criteria to an auditor according to the audit definition;
receiving, on the data interface, audit data in response to the compliance criteria; and
generating a compliance report based upon the received audit data.
